(19) United States
(12) Patent Application Publication
(10) Pub. No.: US 2006/0057326 A1
(43) Pub. Date: Mar. 16, 2006

(54) Scored adhesive-coated photo paper

(75) Inventors: Carl D. Neuburger, Woodbury, MN (US); Mark Andrew Meccia, Chicago, IL (US); Liisa Ann Bayko, Chicago, IL (US)

Correspondence Address: PILLSBURY WINTHROP SHAW PITTMAN, LLP, P.O. BOX 10500, MCLEAN, VA, 22102, US

(73) Assignee: InVision Enterprises International Inc., Palatine, IL (US)

(21) Appl. No.: 11/226,423

(22) Filed: Sep. 15, 2005

Related U.S. Application Data
(60) Provisional application No. 60/610,212, filed on Sep. 16, 2004.

(51) Int. Cl. B32B 33/00

(52) U.S. Cl. 428/42.2

(57) ABSTRACT

The present invention relates to photo substrates onto which images are printed, and particularly to a photo substrate having adhesive on a backside thereof and a scored release liner covering the adhesive.

The present application claims priority to U.S. Provisional Application Ser. No. 60/610,212, filed Sep. 16, 2004, the entirety of which is incorporated into the present application by reference.

### FIELD OF THE INVENTION

The present invention relates to photo substrates onto which images are printed, and particularly to a photo substrate having adhesive on a backside thereof and a scored release liner covering the adhesive.

### BACKGROUND OF THE INVENTION

Substrates with image receiving surfaces especially designed for having photographic images printed thereon by inkjet or other types of printers are well known.

It is also known to provide such photo substrates with a layer of adhesive on the backside thereof and a release liner covering the layer of adhesive. The photo substrate is die cut during manufacturing to define a portion of a predetermined size. Typically, the size of the die-cut portion would be selected from the range of standard photo sizes, e.g., 5 in.×7 in., 4 in.×6 in., etc. Specialized software is required to control the printer so that it prints the photographic image in proper alignment on this die cut portion. When printing is completed, the die cut portion with the photographic image printed thereon is separated at the die cut and then peeled off the release liner. Then, it can be adhered to a surface as desired using the adhesive carried on its backside.

FIG. 1 illustrates an 8.5 inch×11 inch adhesive-backed system 10 with two 5 in.'7 in. die-cut portions of the photo substrate 11. The die-cut portions 12 are being peeled back from the release liner 14. The adhesive is shown at 16 on the backside of the die-cut portions 12.

It is also known to provide an uncut adhesive-backed photo substrate with a release liner having a single score line. The photographic image would be printed on the photo substrate, and, after printing, the score line is used to peel and separate the release liner from the photo substrate and its adhesive. If the image does not occupy the entire photo substrate, the photo substrate, along with the release liner, may be trimmed with scissors or another cutting device prior to peeling back the release liner. FIGS. 2A and 2B show this system 20, with the photo substrate at 22, the release liner at 24, the adhesive at 26, and the score line at 28. Part of the release liner 24 is being peeled back at the score line 28.

This additional approach suffers the shortcoming that an image that does not occupy the whole photo substrate must be printed opposite the score line. Otherwise, when the photo substrate portion with the printed image is trimmed out, the score line will not be available for assisting in peeling back the associated portion of the release liner. This means that the user will have to bend the edge or corner of the photo substrate portion with the image, risking damage to that edge or corner. Trimming the photo substrate after peeling off the release liner via the score line is not a practical solution, as then the user will have to contact the exposed adhesive while trimming. This issue is most problematic when the substrate is 8.5 inches×11 inches, as users may want to print two smaller images (e.g., 4 inches×6 inches, or 5 inches×7 inches) on the substrate. These images typically would each end up on opposing sides of the score line, with the score line not being opposite either one.

### SUMMARY OF THE INVENTION

To overcome the shortcomings of the prior art, one aspect of the present invention provides a system for making adherable photographs. The system comprises a photograph substrate having a photographic image printable surface onto which a printer can print a photographic image; pressure-sensitive adhesive bonded to a backside surface of the photograph substrate opposite the photographic image printable surface; and a release liner covering the pressure-sensitive adhesive. The release liner has a release surface releasably engaging the pressure-sensitive adhesives.

The release liner also has a plurality of score lines for facilitating separation of the release liner from the photograph substrate and the adhesive.

Another aspect of the invention provides a method for making an adherable photograph. The method comprises:

providing a system comprising: (i) a photograph substrate having a photographic image printable surface onto which a printer can print a photographic image; (ii) a pressure-sensitive adhesive bonded to a backside surface of the photograph substrate opposite the photographic image printable surface; and (iii) a release liner covering the pressure-sensitive adhesive, the release liner having a release surface releasably engaging the pressure-sensitive adhesive; the release liner having a plurality of score lines for facilitating separation of the release liner from the photograph substrate and the adhesive;

printing an image on a portion of the photographic image printable surface with the image being opposite at least one of the score lines;

cutting the photograph substrate and the release liner about the printed image; and

using the at least one score line opposite the image to separate the cut-out portion of the release liner from the cut-out portion of the photograph substrate.

Other objects, features, and advantages of the present invention will become apparent from the following detailed description, the accompanying drawings, and the appended claims.

### BRIEF DESCRIPTION OF THE DRAWINGS

FIG. 1 illustrates a prior art system for making adherable photographs.

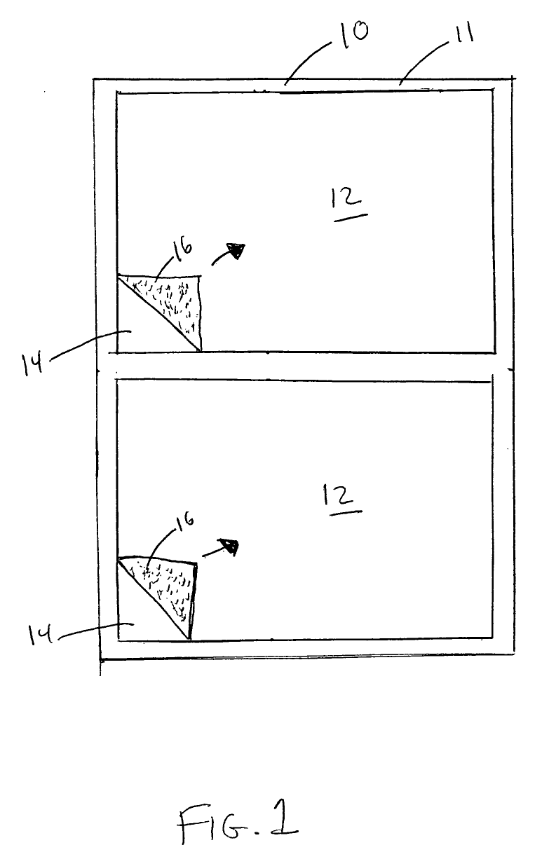

FIGS. 2A and 2B illustrate another prior art system for making adherable photographs;

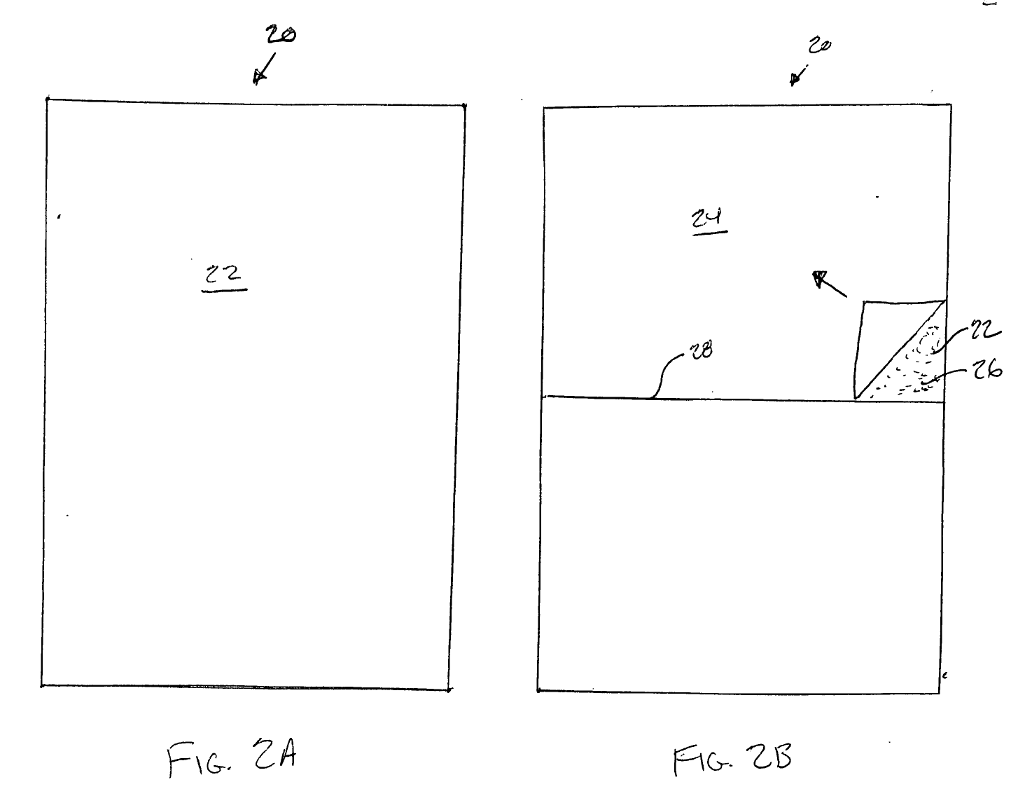

FIG. 3 is a front view of a system for making adherable photographs according to the present invention;

FIG. 4 is a cross-section taken along line 4-4; and

FIG. 5 is a rear view of the system of FIG. 3.

### DETAILED DESCRIPTION OF THE ILLUSTRATED EMBODIMENT

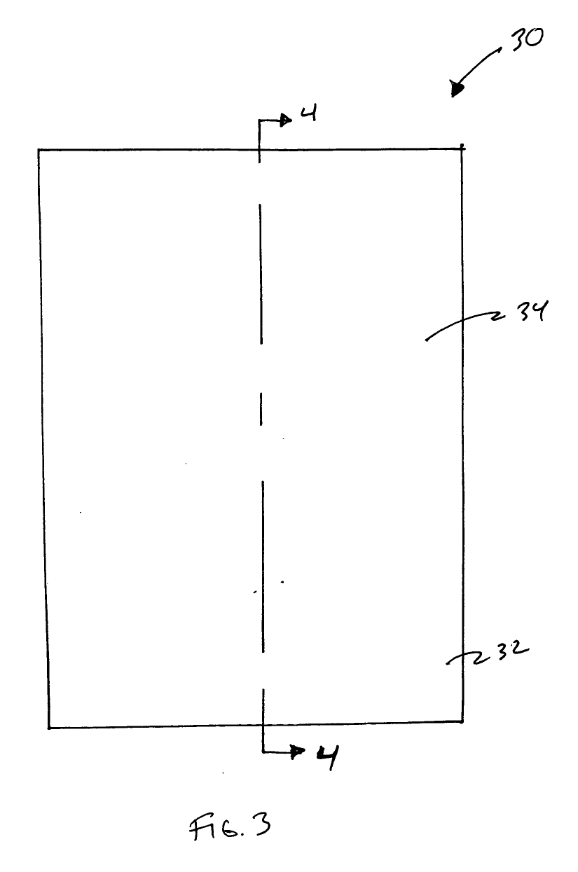

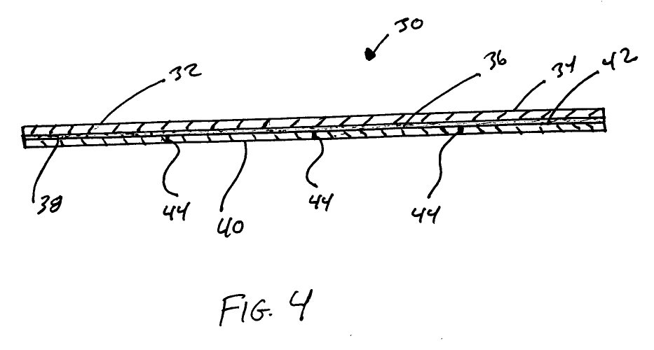

FIG. 3 illustrates a system for making adherable photographs. The system is generally indicated at 30. The system 30 comprises a photograph substrate 32. This photograph substrate 32 has a photographic image printable surface 34. As can be seen in the cross-section of FIG. 4, a pressure-sensitive adhesive 36 is provided on the backside surface 38 of the photograph substrate 32, which is the surface opposite the photographic image printable surface 34.

As used in this application, the term photograph substrate means a substrate with a surface (i.e., the photographic image printable surface 34) especially adapted by a treating or coating for having photographic images printed thereon. Such substrates are characterized by enabling printed photographic images to have a sharp, bright colorful images with high color intensity, and may be designed for use with ink jet printers, dye sublimation printers, or any other type of printer. For example, such substrates may include high quality micro-porous polyethylene coated paper, or a paper with some other coating that serves to enhance printer output by reducing diffusion of the dye or ink, improving hold out, reducing drying time, and/or improving scratch resistance. Other types of coatings may be used. This definition excludes normal paper or other substrates not especially adapted for having photographic images printed thereon.

A release liner 40 covers the adhesive 36. The release liner 40 has a release surface 42 engaging the adhesive 36. The release surface 36 has a lower affinity for bonding with the adhesive than the backside of the photograph substrate 32. This enables the release liner 40 to be peeled back with the adhesive being left on the photo substrate 32. The release surface 42 may be treated with silicone, wax, or any other material to achieve this effect. Preferably, the release liner 40 is of the same size and configuration as the photo substrate 32, and the adhesive 36 is coated over all or almost all of the backside surface 38 of the photograph substrate 32. The photo substrate 32 and the release liner 40 may be of any size, such as 8.5 inches×11 inches, A4, 8.5 inches×14 inches, 13 inches×19 inches, etc.

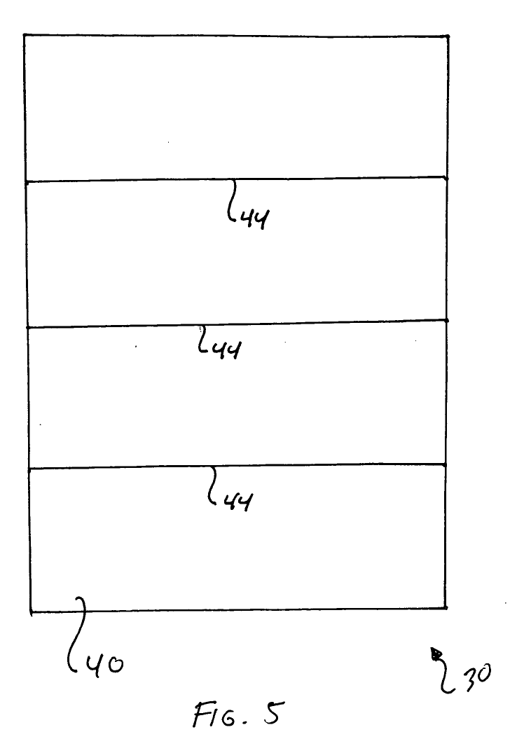

The release liner 40 may have a plurality of score lines 44 for facilitating separation of the photograph substrate 32 and the release liner 40. These score lines 44 preferably extend through the entire, or almost the entire, thickness of the release liner 40. In FIG. 5, these score lines 44 are shown as running laterally with respect to the release liner 40, but they may run longitudinally, diagonally, in wave-like patterns, or in any other conceivable way. With these score lines 42, the photo substrate 32 can be bent slightly to delaminate the sections of release liner 40 adjacent a selected score line 42. Then those delaminated sections can be peeled back to separate those sections of the release liner 40 of the photo substrate 32. As was noted above in the Background section, the use of a single score line across the middle of the release liner 40 is known for this purpose, but the use of a plurality of score lines 42 is particularly advantageous. The reasons for this will be discussed below after describing the way the system 30 is used.

The system 30 with a blank photo substrate 32 can be fed individually, either manually or by a sheet feeder from a stack, into a printer (not shown) that is capable of printing photographic images received from a memory in a personal computer or other type of device. Such images are stored in digital format, and may be compressed for memory saving in accordance with a compression algorithm. For example, the printer could receive the images directly from a digital camera coupled to the printer, or the printer may have a port for receiving a storage medium on which the images are stored and a device for reading those images from the medium. The particular way in which the printer receives the images is not of particular importance and the invention is not intended to be limited to any specific way.

The printer then prints the photographic image on the photographic image printable surface 34. This printing may occur in any suitable way, whether by ink jet printing, dye sublimation or some other suitable method. The system 30 is then discharged from the printer.

Typically, the image will not occupy the entire photo substrate 32, and will only occupy a section thereof. As such, the user may then cut the image out of the system 30. This would be done with the release liner 40 still adhered to the photo substrate 33, thus avoiding the need to handle exposed adhesive during cutting. This cutting may be done using scissors, a punch die cutter, a cutting template, or any other suitable device. The invention is not limited to any particular method of cutting.

Preferably, the density of the score lines 44 is such that any typical size photographic image will be positioned above at least one of the score lines 44. This way, when the photographic image is cut out from the system 30, the cut-out section of the release liner 40 will include at least one score line 44. This is beneficial because it avoids the need for peeling the release liner 40 off the cut-out section of the photograph substrate 32 at the corner or edge, which can be difficult and often leads to damaging the photograph substrate 32. However, any density of score lines 44 may be used. For example, 4 inches by 6 inches and 5 inches by 7 inches are the two most common photograph sizes. Having the score lines 44 spaced less than 4 inches apart would be satisfactory for these sizes to ensure the image is always printed opposite at least one score line 44. For an 8.5 inch by 11 inch substrate, it is preferred to arrange the score lines about 2 inches apart from one another is suitable for printing and cutting 4 inch by 6 inch and 5 inch by 7 inch photographs. As another example, wallet size photographs are typically 2 inches by 3.5 inches, and having the score lines 44 spaced less than 2 inches would be satisfactory to ensure that the image is always printed opposite at least one score line 44. Any other density and or arrangement for the score lines 44 may be used, and those mentioned are not intended to be limiting.

To illustrate the convenience of having a plurality of score lines 44, assume that the score lines 44 extend laterally and parallel as shown in FIG. 5, but are spaced no more than 3 inches apart from one another and the upper and lower edges of the release liner 40. With this construction the user could print twelve 2 inch×3.5 inch photographic images in a 3×4 array on an 8.5 inch×11 inch system 30. The images would be printed with their 3.5 inch direction extending lengthwise of the system, and their 2 inch direction extending laterally. As such, there would be 4 columns of the images in the lateral direction of the system, and 3 rows in the longitudinal direction. With the score line density mentioned, each and every image would be ensured of being opposite a score line 44. This would not be the case if such an array of pictures were printed on a system having only one score line, as was described in the Background section.

The score lines 44 may be formed in any conventional manner. For example, the score lines may be made by die cutting, or in any other manner.

The foregoing illustrated embodiment has been provided solely for illustrating the structural and functional principles of the present invention, and is not intended to be limiting. To the contrary, the present invention is intended to encompass all modifications, substitutions, alterations and equivalents within the spirit and scope of the appended claims.

What is claimed:

1. A system for making adherable photographs comprising:
a photograph substrate having a photographic image printable surface onto which a printer can print a photographic image;
pressure-sensitive adhesive bonded to a backside surface of the photograph substrate opposite the photographic image printable surface; and
a release liner covering the pressure-sensitive adhesive, the release liner having a release surface releasably engaging the pressure-sensitive adhesive;
the release liner having a plurality of score lines for facilitating separation of the release liner from the photograph substrate and the adhesive.

2. A system according to claim 1, wherein the photograph substrate and the release liner both have a size selected from the group consisting of (a) A4, (b) 8.5×14 inches, (c) 8.5×11 inches, and (c) 13×19 inches.

3. A system according to claim 1, wherein the score lines extend entirely through the thickness of the release liner.

4. A system according to claim 1, wherein the score lines extend partially through the thickness of the release liner.

5. A system according to claim 1, wherein the score lines extending in a direction selected from the group consisting of (a) longitudinally in a lengthwise direction of the release liner, (b) laterally in widthwise direction of the release liner, and (c) diagonally with respect to the release liner.

6. A system according to claim 1, wherein the score lines are straight lines.

7. A system according to claim 1, wherein the score lines are continuous lines.

8. A system according to claim 1, wherein the score lines are wave-shaped.

9. A system according to claim 1, wherein the score lines are spaced less than or equal to 4 inches apart.

10. A system according to claim 9, wherein the score lines are spaced less than or equal to 2 inches apart.

11. A system according to claim 1, wherein the score lines are arranged with a density such that a 5×7 inch photographic image printed anywhere on the photographic image printable surface would be opposite at least one of the score lines.

12. A system according to claim 1, wherein the score lines are arranged with a density such that a 4×6 inch photographic image printed anywhere on the photographic image printable surface would be opposite at least one of the score lines.

13. A system according to claim 1, wherein the score lines are arranged with a density such that a 2×3.5 inch photographic image printed anywhere on the photographic image printable surface would be opposite at least one of the score lines.

14. A method for making an adherable photograph:
(a) providing a system comprising: (i) a photograph substrate having a photographic image printable surface onto which a printer can print a photographic image; (ii) a pressure-sensitive adhesive bonded to a backside surface of the photograph substrate opposite the photographic image printable surface; and (iii) a release liner covering the pressure-sensitive adhesive, the release liner having a release surface releasably engaging the pressure-sensitive adhesive; the release liner having a plurality of score lines for facilitating separation of the release liner from the photograph substrate and the adhesive;
(b) printing an image on a portion of the photographic image printable surface with the image being opposite at least one of the score lines;
(c) cutting the photograph substrate and the release liner about the printed image; and
(d) using the at least one score line opposite the image to separate the cut-out portion of the release liner from the cut-out portion of the photograph substrate.

15. A method according to claim 14, wherein:
said printing includes printing multiple spaced apart images on portions of the photographic image printable surface with each image being opposite at least one of the score lines;
said cutting includes cutting the photograph substrate and the release liner about each of the printed images; and
said using the at least one score line includes using each of the at least one score line opposite each image to separate each cut-out portion of the release liner from each cut-out portion of the photograph substrate.
